(19) United States
(12) Patent Application Publication
(10) Pub. No.: US 2026/0116747 A1
(43) Pub. Date: Apr. 30, 2026

(54) HYDROGEN PRODUCTION FROM STREAMS COMPRISING HYDROGEN SULFIDE

(71) Applicant: Ohio State Innovation Foundation, Columbus, OH (US)

(72) Inventors: Liang-Shih Fan, Columbus, OH (US); Sonu Kumar, Columbus, OH (US)

(21) Appl. No.: 19/158,340

(22) PCT Filed: Apr. 4, 2024
(86) PCT No.: PCT/US2024/022992

§ 371 Date: Aug. 20, 2025

Related U.S. Application Data
(60) Provisional application No. 63/457,207, filed on Apr. 5, 2023.

(51) Int. Cl. C01B 3/04

(52) U.S. Cl. CPC C01B 3/04; C01B 2203/0277; C01B 2203/1047; C01B 2203/1205; C01B 2203/1614

(57) ABSTRACT

A system may include a gas inlet configured to receive a gas stream comprising hydrogen sulfide (H₂S), a first particle bed comprising a plurality of first particles, the first particles comprising a support material and a first metal material comprising at least one of: iron (Fe), nickel (Ni), chromium (Cr), cobalt (Co), vanadium (V), copper (Cu), and cerium (Ce); and the first particle bed in fluid communication with the gas inlet. A system may include a second particle bed comprising a plurality of second particles comprising a support material and a second metal material comprising at least one of: iron (Fe), chromium (Cr), nickel (Ni), and vanadium (V), the second particle bed being in fluid communication with the first particle bed. A system may include a gas outlet in fluid communication with the second particle bed, the gas outlet being configured to provide an output stream comprising hydrogen (H₂) gas.

### CROSS-REFERENCE TO RELATED APPLICATIONS

This application claims priority to U.S. Provisional Patent Application No. 63/457,207, filed on Apr. 5, 2023, the entire contents of which are incorporated herein by reference.

### TECHNICAL FIELD

The present disclosure relates to systems, methods, and techniques for hydrogen production from streams comprising hydrogen sulfide.

### INTRODUCTION

Hydrogen sulfide (H₂S), which occurs naturally in crude fossil fuels like natural gas, petroleum, and coal, is highly flammable and corrosive. When present in process feed streams, it can cause catalyst poisoning and material corrosion. Additionally, its release into the atmosphere can be fatal and lead to acid rain. Even at low concentrations of 10 ppm, exposure to H₂S can be harmful to humans. Therefore, refining processes are necessary to remove H₂S before these fuels can be used.

A variety of processes are used to separate and treat hydrogen sulfide from sour or acid gas streams. Liquid solvent absorption using substances like amines or alcohol is commonly used for separation, generating a concentrated stream of hydrogen sulfide during the solvent regeneration step. This stream is then sent to the Claus process for decomposition into steam and elemental sulfur. However, the Claus process cannot handle high concentrations of hydrocarbons, hydrogen, or oxidative gases, so solvent absorption is necessary for separation and concentration. The process also requires multiple catalyst beds due to thermodynamic constraints and the kinetics of the catalytic step, and overall sulfur recovery is limited to approximately 97%. In addition, the process cannot recover hydrogen (H₂) along with sulfur, as it is lost in the form of water vapor. Moreover, tail gas cleanup is necessary to reduce the concentration of sulfur dioxide (SO₂) to acceptable levels set by environmental agencies.

### SUMMARY

In some aspects, the techniques described herein relate to a reactor system, including: a gas inlet configured to receive a gas stream including hydrogen sulfide (H₂S); a first particle bed including a plurality of first particles, the first particles including a support material and a first metal material, the first metal material including at least one of: iron (Fe), nickel (Ni), chromium (Cr), cobalt (Co), vanadium (V), copper (Cu), and cerium (Ce); and the first particle bed in fluid communication with the gas inlet; and a second particle bed including a plurality of second particles, the second particles including a support material and a second metal material including at least one of: iron (Fe), chromium (Cr), nickel (Ni), and vanadium (V), the second particle bed being in fluid communication with the first particle bed; and; a gas outlet in fluid communication with the second particle bed, the gas outlet being configured to provide an output stream including hydrogen (H₂) gas.

In some aspects, the techniques described herein relate to a method of operating a reactor system, the method including: providing a gas stream including hydrogen sulfide (H₂S) gas to a first particle bed, the first particle bed including a plurality of first particles, the first particles including a support material, sulfur (S) material, and a first metal; controlling a temperature of the first particle bed to be between 50° C. and 800° C.; contacting an output stream from the first particle bed with a second particle bed, the second particle bed including a plurality of second particles, the second particles including a support material, sulfur (S) material, iron (Fe), and chromium (Cr); and controlling a temperature of the second particle bed to be between 50° C. and 800° C.; and collecting an output stream from the second particle bed, the output stream including hydrogen (H₂) gas.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways.

### BRIEF DESCRIPTION OF THE DRAWINGS

FIG. 1 schematically illustrates an exemplary two-reactor configuration in an exemplary sulfidation operation and in an exemplary regeneration operation.

FIG. 2 schematically illustrates an exemplary reactor system comprising “n” reactors in series.

FIG. 3 schematically illustrates an exemplary single-reactor configuration in an exemplary sulfidation operation and in an exemplary regeneration operation.

FIG. 4 schematically illustrates an exemplary single-reactor configuration comprising ‘n’ number of beds.

FIG. 5 schematically illustrates a single reactor configuration where a single type of metal sulfide particle is used in an exemplary sulfidation operation and in an exemplary regeneration operation.

FIG. 6 shows experimental data for hydrogen sulfide (H₂S) in the presence of hydrogen (H₂) (0 to 99%), as shown in FIG. 6.

FIG. 7 shows experimental data for hydrogen sulfide (H₂S) conversion over FeS at 200° C. for different hydrogen (H₂) concentrations in the co-feed.

FIG. 8 shows experimental data for hydrogen sulfide (H₂S) conversion over Ni₃S₂ at 500° C. for different hydrogen (H₂) concentrations in the co-feed.

FIG. 9A schematically illustrates an exemplary two-reactor configuration where a first reactor comprises iron (Fe)-based sulfur carrier particles and a second reactor comprises FeCr-based sulfur carrier particles. FIG. 9B schematically illustrates an exemplary two-reactor configuration where a first reactor comprises nickel (Ni)-based sulfur carrier particles and a second reactor comprises FeCr-based sulfur carrier particles.

### DETAILED DESCRIPTION

The present disclosure relates to the systems, methods, reactor configuration, and operating strategies for optimizing the valorization of hydrogen sulfide to hydrogen and sulfur through modularization by operating multiple reactors or beds in series to ensure concurrent high gas and solids conversion. The multiple reactors or beds leverage the thermodynamic properties of different metal-based materials to convert hydrogen sulfide from a gaseous stream to hydrogen, maximizing the per-pass hydrogen yield for minimizing processes' energy and cost requirements. The proposed schemes can be integrated with any pre-existing processes that consume or generate a hydrogen sulfide-containing gas stream during their operation.

### I. Definitions

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “about” is used to indicate that exact values are not necessarily attainable. Therefore, the term “about” is used to indicate this uncertainty limit. The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5-1.4. The modifier “about” should also be considered as disclosing the range defined by the absolute values of the two endpoints. For example, the expression “from about 2 to about 4” also discloses the range “from 2 to 4.”

For the recitation of numeric ranges herein, each intervening number there between with the same degree of precision is contemplated. For example, for the range of 6-9, the numbers 7 and 8 are contemplated in addition to 6 and 9, and for the range 6.0-7.0, the numbers 6.0, 6.1, 6.2, 6.3, 6.4, 6.5, 6.6, 6.7, 6.8, 6.9, and 7.0 are contemplated. For another example, when a pressure range is described as being between ambient pressure and another pressure, a pressure that is ambient pressure is expressly contemplated.

Definitions of specific functional groups and chemical terms are described in more detail below. For purposes of this disclosure, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

### II. Exemplary Systems

Exemplary systems involve cyclic processes that produce H₂ and sulfur from the H₂S-containing gaseous mixture.

The H₂S decomposition occurs in two operations-sulfidation and regeneration. In the sulfidation operations, the H₂S from the feed stream passes through a series of reactors and reacts with multiple metal composite solids located in these different reactors, which captures the sulfur part of H₂S and releases H₂ as the product. During sulfidation operations, the different reactors in series can be at the same or different temperatures.

At the end of the sulfidation operations, the said solids get converted into the single metal sulfide phases, the bimetallic sulfide phase (thiospinel) of metals present in the metal composite used, or both. The said mixture of sulfides obtained after the sulfidation operations can then be regenerated in a regeneration step by heating up to a higher temperature in the presence of inert gases, including but not limited to nitrogen (N₂), argon (Ar), helium (He), or carbon dioxide (CO₂) to recover the captured sulfur.

During regeneration operations, the different reactors in series can be at the same or different temperatures. The completion of one sulfidation and one regeneration operation is referred to as one cycle. The mentioned composite solids may also comprise secondary, tertiary, and quaternary components.

### A. Exemplary Particles

Various types of metal sulfide particles may be utilized in exemplary systems and methods. Generally, metal sulfide particles used in exemplary systems and methods are either in a reduced form or in an oxidized form. The reduced or oxidized terms refer to the change in oxidation state of the metal, lattice sulfur species, or both. Exemplary particles comprise an active metal capable of forming sulfides.

Broadly, exemplary metal sulfide particles may be categorized as “first particles” or “second particles.” Exemplary first particles may comprise a support material and a first metal material. Exemplary first metal materials may comprise iron (Fe), nickel (Ni), chromium (Cr), cobalt (Co), vanadium (V), copper (Cu), cerium (Ce), or mixtures thereof.

Exemplary second particles may comprise a support material and a second metal material. Exemplary second metal materials may comprise iron (Fe), nickel (Ni), chromium (Cr), vanadium (V), or mixtures thereof. In some implementations, exemplary second particles comprise iron and chromium.

In some implementations, the first particles may comprise iron (Fe) and the second particles may comprise iron (Fe) and chromium (Cr). In some implementations, the first particles may comprise nickel (Ni) and the second particles may comprise iron (Fe) and chromium (Cr).

In some implementations, materials for the first particles and the second particles are selected such that a sulfur uptake capacity of the first particles is greater than a sulfur update capacity of the second particles. As an example, a sulfur uptake capacity of the first particles may be no less than 4 grams sulfur (S) per 100 grams of particle. In various implementations, the sulfur uptake capacity of the first particles may be, per 100 grams of particle, no less than 5 grams sulfur (S); no less than 10 grams S; no less than 15 grams S; no less than 20 grams S; no less than 25 grams S; no less than 30 grams S; or no less than 35 grams S per 100 grams of particle. In various implementations, the sulfur uptake capacity of the first particles may be, per 100 grams of particle, no greater than 36 grams sulfur (S); no greater than 31 grams S: no greater than 26 grams S; no greater than 21 grams S; no greater than 16 grams S; no greater than 11 grams S; or no greater than 6 grams S per 100 grams of particle. In various implementations, the sulfur uptake capacity of the first particles may be, per 100 grams of particle, between 4-100 grams sulfur (S); between 4-50 grams sulfur (S); between 50-100 grams sulfur (S); between 25-75 grams sulfur (S); between 4-33 grams sulfur (S); between 33-66 grams sulfur (S); or between 66-100 grams sulfur (S).

As an example, a sulfur uptake capacity of the second particles may be no greater than 20 grams sulfur (S) per 100 grams of particle. In various implementations, the sulfur uptake capacity of the second particles may be, per 100 grams of particle, no less than 1 gram sulfur (S); no less than 5 grams sulfur (S); no less than 10 grams S; no less than 15 grams S; or no less than 20 grams S per 100 grams of particle. In various implementations, the sulfur uptake capacity of the second particles may be, per 100 grams of particle, no greater than 20 grams S; no greater than 16 grams S; no greater than 11 grams S; no greater than 6 grams S; no greater than 4 grams S; or no greater than 2 grams S per 100 grams of particle. In various implementations, the sulfur uptake capacity of the second particles may be, per 100 grams of particle, between 1-20 grams S; between 1-10 grams S; between 10-20 grams S; between 1-5 grams S; between 5-15 grams S; or between 1-3 grams S.

Exemplary metal sulfide particles may be synthesized by any suitable method including, but not limited to, wet milling, extrusion, pelletizing, freeze granulation, co-precipitation, wet-impregnation, sol-gel, and mechanical compression. Certain techniques may be used to increase the strength and/or reactivity of exemplary metal sulfide particles, such as sintering synthesized particles or adding a binder or sacrificial agent with synthesis methods such as sol-gel combustion.

Exemplary metal sulfide particles may be provided as powders or pellets. Example powders may include metal sulfide particles having a size of about 100 μm. Example pellets may include metal sulfide particles having a size of about 2 mm.

Example metal sulfide particles may be bulk structures or mesoporous supported nanoparticles. Example bulk structures may have random orientations of large grains, cage-like structures for added physical strength, layered structure, or similar configurations. Example mesoporous supported metal sulfide particles may have a mesoporous support such as Santa Barbara Amorphous-15 silica (SBA-15), Santa Barbara Amorphous-16 silica (SBA-16), and other SBA variants, Mesoporous-Al₂O₃, Mesoporous CeO₂, etc., which have micro- and mesopores, in which metal sulfide nanoparticles may be embedded.

### B. Exemplary System Configurations

Exemplary systems may comprise one or more reactors. Typically, exemplary reactors discussed below are configured as fixed bed reactors.

Generally, exemplary reactor systems comprise at least one gas inlet and a first particle bed. Exemplary at least one gas inlets are configured to receive a gas stream comprising hydrogen sulfide (H₂S). The first particle bed comprises a plurality of first particles as described in greater detail above. In some instances, exemplary reactor systems may comprise a second particle bed. The second particle bed is in fluid communication with the first particle bed. Exemplary reactor systems also include a gas outlet in fluid communication with the second particle bed. The gas outlet may be configured to provide an output stream comprising hydrogen (H₂) gas.

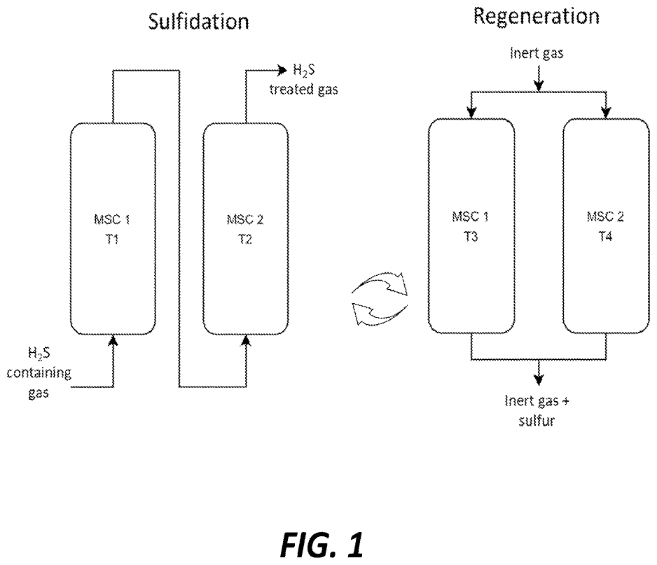

FIG. 1 schematically illustrates an exemplary two-reactor configuration. During sulfidation operations, the H₂S-containing gas stream is injected into reactor 1. Reactor 1 comprises first particles, termed metal sulfide composite 1 (MSC 1), and operates at temperature T1. In various implementations, 40 mole percent (mol %) to 95 mol % of H₂S present at the reactor inlet is converted to H₂ in reactor 1. The outlet of reactor 1, containing the unconverted H₂S, formed H₂, and other gaseous components, is provided to reactor 2.

Reactor 2 comprises second particles, termed metal sulfide composite 2 (MSC 2), and operates at temperature T2. Unreacted H₂S from reactor 1 outlet is converted to H₂ in reactor 2. The outlet stream of reactor 2 includes negligible unconverted H₂S (0-10 mol %). Once the sulfidation operations are completed, both the reactors can undergo regeneration. During regeneration operations, the reactors may be operated at the same or different temperatures (T3 and T4).

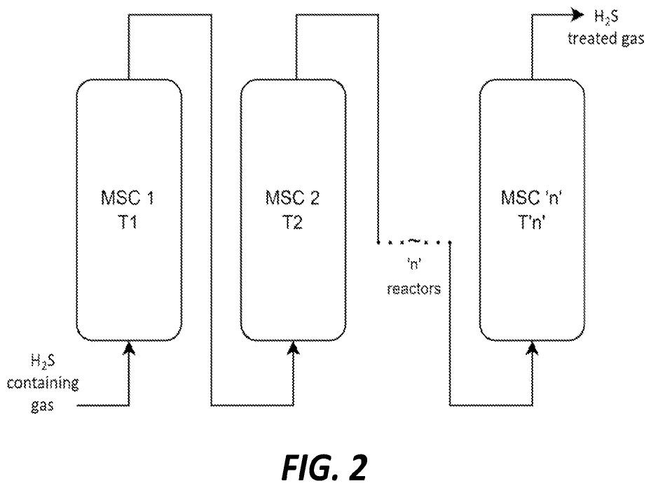

FIG. 2 schematically illustrates an exemplary reactor system comprising “n” reactors in series. The n reactors (R1 to R‘n’) may contain up to ‘n’ different kinds of metal sulfide composite carriers. The n reactors (R1 to R‘n’) may operate at the same or different temperatures during both the sulfidation and regeneration operations.

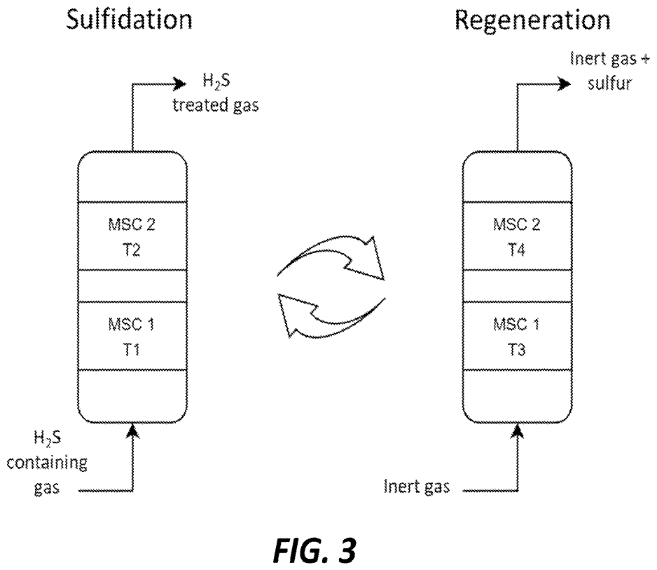

FIG. 3 schematically illustrates an exemplary single-reactor configuration. As shown, the single reactor comprises two beds, each bed comprising different solid particle materials.

During the sulfidation operations, an H₂S-containing gas stream would first contact bed 1, which comprises metal sulfide composite 1 (MSC 1) and operates at temperature T1. About 40-95 mol % of H₂S present in the reactor inlet may be converted to H₂ in the bed with MSC 1.

The exit gas of bed 1, comprising unconverted H₂S, formed H₂, and other gaseous components, contacts bed 2. Bed 2 comprises metal sulfide composite 2 (MSC 2) and operates at temperature T2. Unreacted H₂S from bed 1 may be converted to H₂ while passing through bed 2. The outlet stream from the reactor comprises negligible unconverted H₂S (0-10 mol %). Once the sulfidation operations are completed, the whole reactor can undergo regeneration at the same or different temperatures (T3 and T4). In some instances, more than one of the single reactors shown in FIG. 3 may be arranged in series.

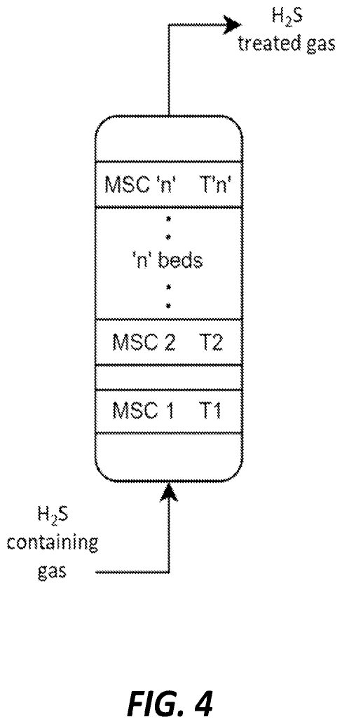

FIG. 4 schematically illustrates an exemplary single-reactor configuration comprising ‘n’ number of beds. The ‘n’ beds may comprise up to ‘n’ different kinds of metal sulfide particles. Each bed within the reactor may operate at the same or different temperatures during sulfidation and regeneration operations. In some instances, more than one of the single reactors shown in FIG. 4 may be arranged in series.

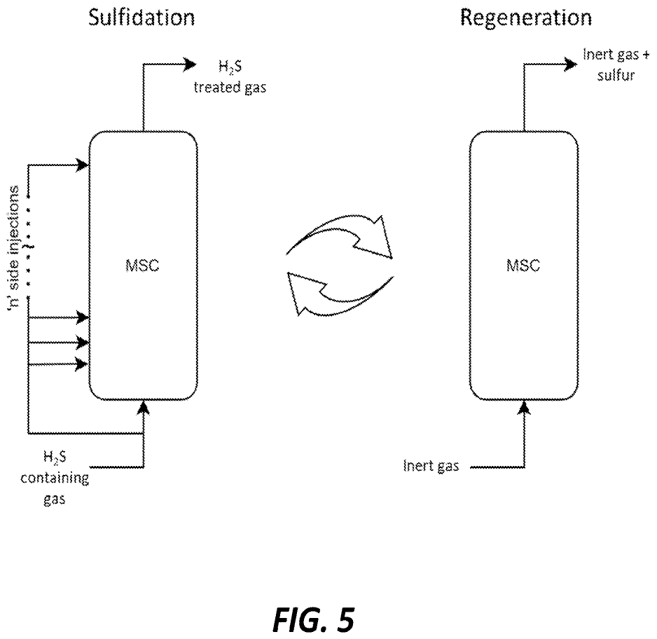

FIG. 5 schematically illustrates a single reactor configuration where a single type of metal sulfide particle is used. During sulfidation operations, an H₂S-containing gas stream can be split into up to ‘n’ streams and injected into the reactor from up to ‘n’ side ports. Without being bound by a particular theory, the configuration shown in FIG. 5 may help break the thermodynamic equilibrium of the gas-solid system for maximizing gas conversion and overall material sulfur uptake capacity.

The outlet stream from the reactor has negligible H₂S (0-10 mol %). Once the sulfidation operations are completed, the whole reactor can undergo regeneration operations at the same or different temperatures. The side injection strategy can be utilized for schemes illustrated earlier in FIG. 1, FIG. 2, FIG. 3, and/or FIG. 4.

### III. Exemplary Methods of Operation

Various methods of operation may be used with exemplary systems described above.

In some instances, an exemplary method of operating a reactor system may comprise providing a gas stream comprising hydrogen sulfide (H₂S) gas to a first particle bed. The gas stream may comprise between 0.5 mol % and 95 mol % hydrogen sulfide (H₂S) gas. Exemplary gas streams may comprise various other constituents, which may vary depending on the implementation and/or industry. As examples, exemplary gas streams may comprise one or more of: carbon dioxide (CO₂), carbon monoxide (CO), hydrogen gas (H₂), steam (H₂O), carbonyl sulfide (COS), ammonia (NH₃), nitrogen gas (N₂), methane (CH₄), other C2-, C3-, and C4-alkanes, and other inert components.

In some instances, the gas stream is provided to an inlet of a reactor. In some instances, the gas stream is provided via a plurality of inlets of a reactor. In some instances, the gas stream is provided via a plurality of inlets arranged along a length of the first particle bed.

The temperature of the first particle bed may be controlled to be within a predetermined temperature range. In some instances, the predetermined temperature range of the first particle bed may be related to the chemical constituents of the first particles in the first particle bed.

In some implementations, the first particle bed temperature may be controlled to be between about 50° C. and about 800° C. In various implementations, the first particle bed temperature may be controlled to be between 50-800° C.; between 100-700° C.; between 200-800° C.; between 150-550° C.; between 100-300° C.; or between 150-250° C. In various implementations, the first particle bed temperature may be controlled to be no less than 50° C.; no less than 100° C.; no less than 150° C.; no less than 200° C.; no less than 250° C.; no less than 300° C.; no less than 350° C.; no less than 400° C.; no less than 450° C.; no less than 500° C.; no less than 550° C.; no less than 600° C.; no less than 650° C.; no less than 700° C.; or no less than 750° C. In various implementations, the first particle bed temperature may be controlled to be no greater than 800° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; no greater than 125° C.; or no greater than 75° C.

An output stream from the first particle bed comprises, at least, hydrogen gas (H₂) and hydrogen sulfide (H₂S). Because exemplary input gas streams may comprise various amounts of hydrogen sulfide (H₂S), output streams are discussed below in terms of hydrogen sulfide (H₂S) conversion. Hydrogen sulfide (H₂S) conversion is defined as the difference of moles of hydrogen sulfide (H₂S) in the input stream compared to the moles of hydrogen sulfide (H₂S) in the output stream, divided by the moles of hydrogen sulfide (H₂S) in the input stream, and expressed as a percentage.

In some instances, the output stream from the first particle bed may have a hydrogen sulfide (H₂S) conversion of about 40% to about 90%, relative to the gas stream provide to the first particle bed. In various implementations, the output stream from the first particle bed may have a hydrogen sulfide (H₂S) conversion of no less than 40% hydrogen gas (H₂); no less than 50% hydrogen gas (H₂); no less than 60% hydrogen gas (H₂); no less than 70% hydrogen gas (H₂); no less than 80% hydrogen gas (H₂); or no less than 90% hydrogen gas (H₂). In various implementations, the output stream from the first particle bed may have a hydrogen sulfide (H₂S) conversion of no greater than 90% hydrogen gas (H₂); no greater than 80% hydrogen gas (H₂); no greater than 70% hydrogen gas (H₂); no greater than 60% hydrogen gas (H₂); no greater than 50% hydrogen gas (H₂); or no greater than 40% hydrogen gas (H₂). In various implementations, the output stream from the first particle bed may have a hydrogen sulfide (H₂S) conversion between 40-90%; between 40-75%; between 75-90%; between 50-80%; between 40-60%; between 60-80%; or between 80-90%.

In some instances, an exemplary method of operating a reactor system may comprise contacting an output stream from the first particle bed with a second particle bed. In some instances, the output stream may be provided via a plurality of inlets arranged along a length of the second particle bed.

In some instances, the output stream from the first particle bed is collected from one reactor and provided to a different reactor comprising the second particle bed. In some instances, the output stream from the first particle bed flows in the same reactor until contacting the second particle bed.

The temperature of the second particle bed may be controlled to be within a predetermined temperature range. In some instances, the predetermined temperature range of the second particle bed may be related to the chemical constituents of the second particles in the second particle bed.

In some implementations, the second particle bed temperature may be controlled to be between about 50° C. and about 800° C. In various implementations, the second particle bed temperature may be controlled to be between 50-800° C.; between 100-700° C.; between 200-800° C.; between 300-600° C.; between 400-800° C.; between 300-500° C.; or between 350-450° C. In various implementations, the second particle bed temperature may be controlled to be no less than 50° C.; no less than 100° C.; no less than 150° C.; no less than 200° C.; no less than 250° C.; no less than 300° C.; no less than 350° C.; no less than 400° C.; no less than 450° C.; no less than 500° C.; no less than 550° C.; no less than 600° C.; no less than 650° C.; no less than 700° C.; or no less than 750° C. In various implementations, the second particle bed temperature may be controlled to be no greater than 800° C.; no greater than 775° C.; no greater than 725° C.; no greater than 675° C.; no greater than 625° C.; no greater than 575° C.; no greater than 525° C.; no greater than 475° C.; no greater than 425° C.; no greater than 375° C.; no greater than 325° C.; no greater than 275° C.; no greater than 225° C.; no greater than 175° C.; no greater than 125° C.; or no greater than 75° C.

In some implementations, the second particle bed temperature may be greater than the first particle bed temperature. For instance, when the second particles comprise iron (Fe) and chromium (Cr) and the first particles comprise iron and/or nickel, the first particle bed may be operated at a temperature between 100-300° C. and the second particle bed may be operated at a temperature between 300-500° C.

An output stream from the second particle bed comprises, at least, hydrogen gas (H₂) and hydrogen sulfide (H₂S). In some instances, the output stream from the second particle bed may have a hydrogen sulfide (H₂S) conversion, determined relative to the input stream provided to the first particle bed, of about 90% to about 99.9%. In various implementations, the output stream from the second particle bed may have a hydrogen sulfide (H₂S) conversion no less than 90%; no less than 92%; no less than 94%; no less than 96%; no less than 98%; or no less than 99%. In various implementations, the output stream from the second particle bed may have a hydrogen sulfide (H₂S) conversion no greater than 99.9%; no greater than 97%; no greater than 95%; no greater than 93%; no greater than 91%; or no greater than 90 mol %. In various implementations, the output stream from the second particle bed may have a hydrogen sulfide (H₂S) conversion between 90-99.9%; between 90-95%; between 95-99.9%; between 90-93%; between 93-97%; or between 97-99.9%.

The output stream from the second particle bed may comprise about 0.1% to about 5%, by moles, of the hydrogen sulfide (H₂S) provided in the gas stream to the first particle bed. In various implementations, the output stream from the second particle bed may comprise, by moles, no more than 5%; no more than 4%; no more than 3%; no more than 2%; or no more than 1% of the hydrogen sulfide (H₂S) provided in the gas stream to the first particle bed.

Exemplary methods may also include regeneration operations. For instance, exemplary methods may include regenerating the first particle bed, which may comprise providing a first inert gas to the first particle bed. Exemplary inert gases include, but are not limited to, nitrogen (N₂), argon (Ar), helium (He), carbon dioxide (CO₂), and combinations thereof.

In various implementations, regenerating the first particle bed may be conducted at a temperature between about 500° C. and about 1200° C. In various instances, regenerating the first particle bed may be conducted at a temperature no less than 500° C.; no less than 600° C.; no less than 700° C.: no less than 800° C.; no less than 900° C.; no less than 1000° C.; no less than 1100° C.; or no less than 1200° C. In various instances, regenerating the first particle bed may be conducted at a temperature no greater than 1200° C.; no greater than 1100° C.; no greater than 1000° C.; no greater than 900° C.; no greater than 800° C.; no greater than 700° C.; no greater than 600° C.; or no greater than 500° C. In various instances, regenerating the first particle bed may be conducted at a temperature between 500-1200° C.; between 500-850° C.; between 850-1200° C.; between 600-1100° C.; between 700-1000° C.; between 500-700° C.; between 700-900° C.; between 900-1100° C.; or between 1000-1200° C.

Exemplary methods may include regenerating the second particle bed, which may comprise providing a second inert gas to the second particle bed. Exemplary inert gases include, but are not limited to, nitrogen (N₂), argon (Ar), helium (He), carbon dioxide (CO₂), and combinations thereof.

In various implementations, regenerating the second particle bed may be conducted at a temperature between about 500° C. and about 1200° C. In various instances, regenerating the second particle bed may be conducted at a temperature no less than 500° C.; no less than 600° C.; no less than 700° C.; no less than 800° C.; no less than 900° C.; no less than 1000° C.; no less than 1100° C.; or no less than 1200° C. In various instances, regenerating the second particle bed may be conducted at a temperature no greater than 1200° C.; no greater than 1100° C.; no greater than 1000° C.; no greater than 900° C.; no greater than 800° C.; no greater than 700° C.: no greater than 600° C.; or no greater than 500° C. In various instances, regenerating the second particle bed may be conducted at a temperature between 500-1200° C.; between 500-850° C.; between 850-1200° C.; between 600-1100° C.; between 700-1000° C.; between 500-700° C.; between 700-900° C.; between 900-1100° C.; or between 1000-1200° C.

### IV. Computational and Experimental Data

Exemplary experimental examples were computationally generated and the results are discussed below.

Thermodynamic calculations were performed for various metal sulfides in different temperature ranges. Because the reactant H₂S reacts with the sulfur-lean metal sulfide to produce H₂ in the first reactor/bed, the presence of H₂ may inhibit high H₂S conversion to H₂ in the subsequent reactors/beds. So, the effect of the presence of H₂ in the H₂S stream was also studied.

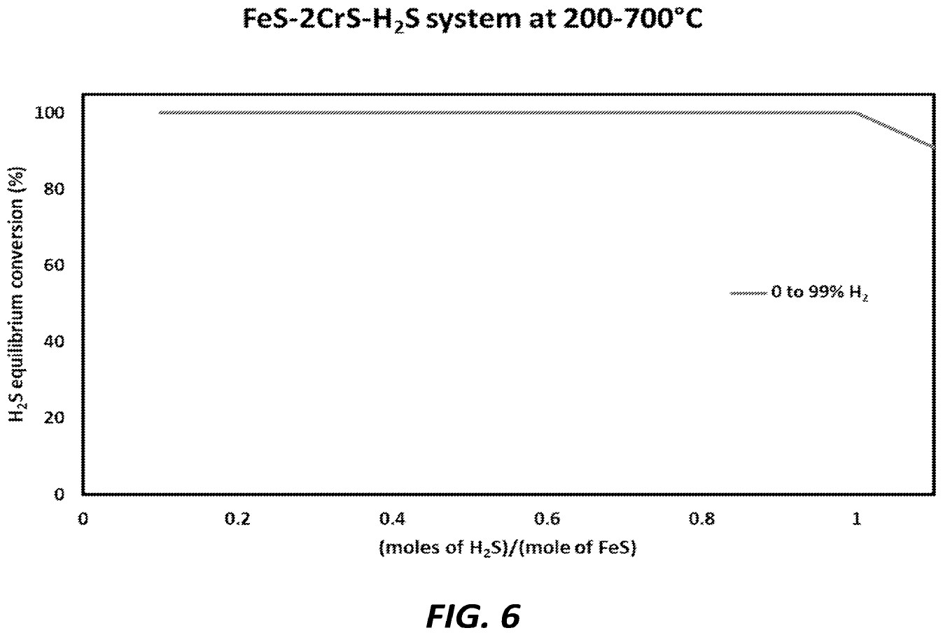

Firstly, the combination of FeS+2CrS was studied. FeS+2CrS reacts with the sulfur present in H₂S to give FeCr₂S₄ (thio-spinel) and H₂ (Equation 1). This reaction is favorable in the temperature range of 100° C. to 800° C. The H₂S conversion for this reaction under thermodynamic equilibrium is calculated >99%. This conversion is unaffected by the presence of H₂ (0 to 99%), as shown in FIG. 6. Hence the combination of FeS and CrS is a material for high H₂S conversion in the cyclic two-step H₂S decomposition system. However, the XRD plots shown in U.S. patent Ser. No. 11/413,574B2 reveal that post the regeneration step of the thiospinel phase (FeCr₂S₄), the major phase present is still FeCr₂S₄. This indicates a low sulfur-uptake capacity of the material for the subsequent cycles.

$$FeS + 2 CrS + {H}_{2} S \to {FeCr}_{2} {S}_{4} + {H}_{2} \qquad Equation ( 1 )$$

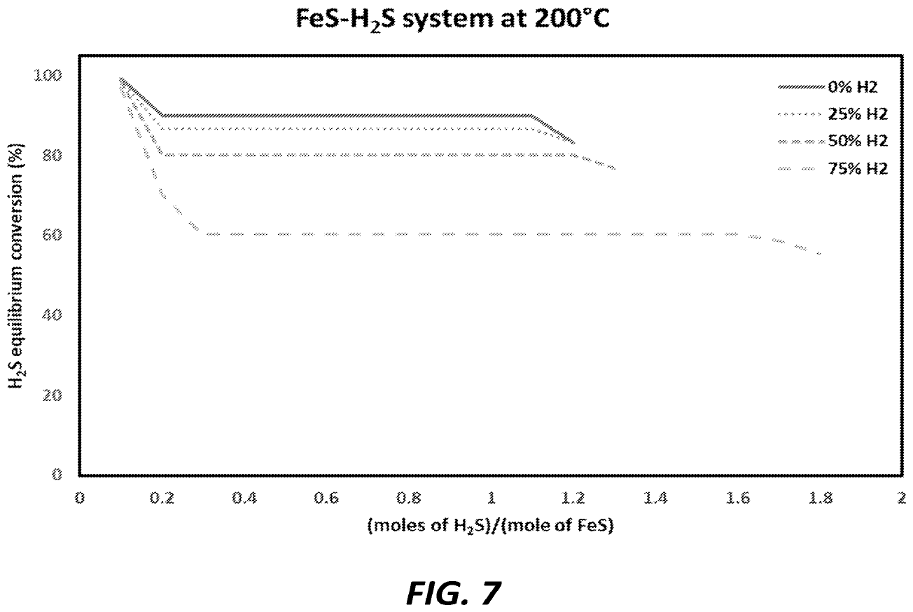

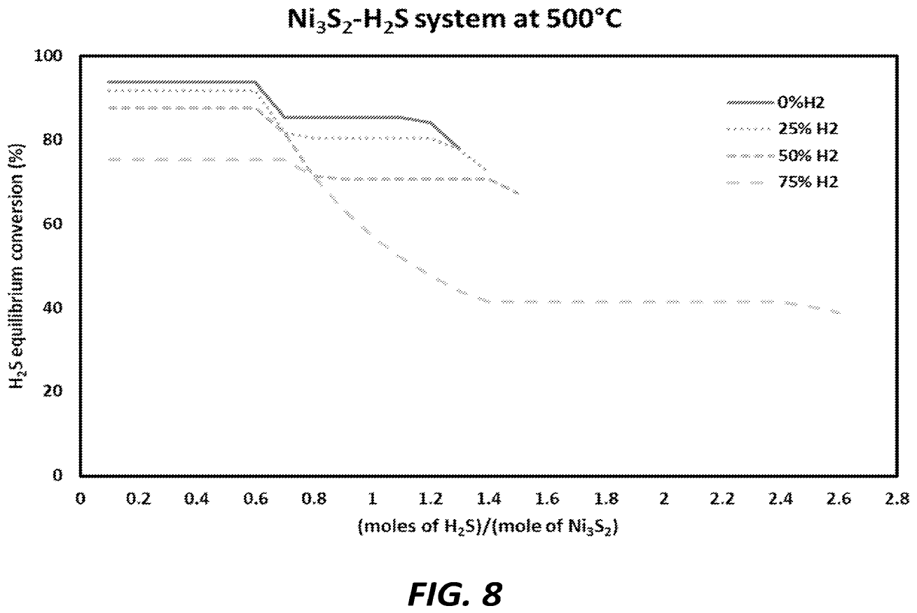

Hence, the mentioned material can be used in combination with a material with high sulfur capacity and high regenerability. The literature shows that Fe and Ni-based sulfides can exhibit a high sulfur swing and recyclability between their sulfur-lean and sulfur-rich phases. The thermodynamic performance of FeS and Ni₃S₂ was also evaluated for a range of temperatures. The effect of the presence of H₂ was also studied. The plot for moles of H₂S vs. H₂S conversion over FeS at 200° C. for different H₂ concentrations in the co-feed is shown in FIG. 7. Under no H₂, the equilibrium H₂S conversion is limited to ˜90%. The conversion further drops as the proportion of H₂ in the feed stream increases and reaches ˜60% at 75% H₂ concentration in the feed gas. The plot for moles of H₂S vs. H₂S conversion over Ni₃S₂ at 500° C. for different H₂ concentrations in the co-feed is shown in FIG. 8. At the solid saturation point, the H₂S conversion is calculated at 85%. However, the conversion drops as the proportion of H₂ in the feed stream increases. At 50% H₂ concentration in the feed, the H₂S conversion is ˜70%.

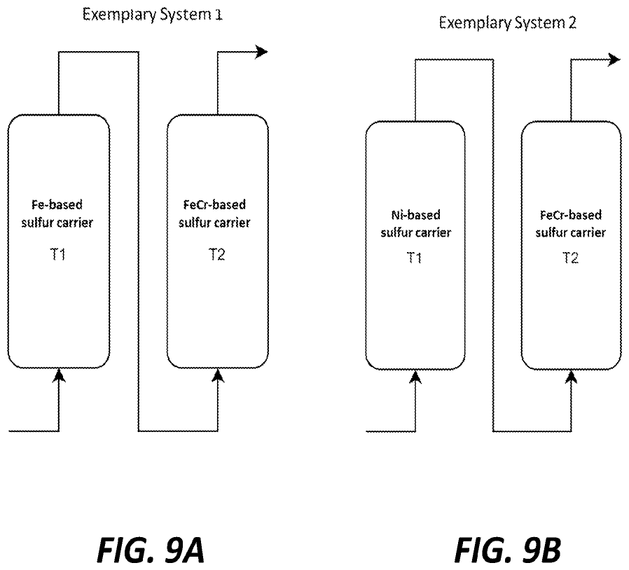

A modular system exploiting the thermodynamic properties of the metal sulfides can be employed to achieve a high H₂S conversion with high sulfur capacity. Two exemplary systems are illustrated in FIG. 9A and FIG. 9B. In the first system, the first reactor uses the Fe-based sulfur carrier (high sulfur capacity), and the second reactor uses the FeCr-based sulfur carrier (high H₂S conversion). The operating conditions for both reactors can be optimized based on the properties of sulfur carrier materials in the respective reactors. In the second exemplary system, the first reactor uses the Ni-based sulfur carrier (high sulfur capacity), and the second reactor uses the FeCr-based sulfur carrier (high H₂S conversion).

For reasons of completeness, the following Clauses are provided.
Clause 1. A reactor system, comprising: a gas inlet configured to receive a gas stream comprising hydrogen sulfide (H₂S); a first particle bed comprising a plurality of first particles, the first particles comprising a support material and a first metal material, the first metal material comprising at least one of: iron (Fe), nickel (Ni), chromium (Cr), cobalt (Co), vanadium (V), copper (Cu), and cerium (Ce); and the first particle bed in fluid communication with the gas inlet; and a second particle bed comprising a plurality of second particles, the second particles comprising a support material and a second metal material comprising at least one of: iron (Fe), chromium (Cr), nickel (Ni), and vanadium (V), the second particle bed being in fluid communication with the first particle bed; and; a gas outlet in fluid communication with the second particle bed, the gas outlet being configured to provide an output stream comprising hydrogen (H₂) gas.
Clause 2. The reactor system according to clause 1, wherein a sulfur uptake capacity of the first particles is greater than a sulfur update capacity of the second particles.
Clause 3. The reactor system according to clause 2, wherein the sulfur uptake capacity of the first particles is no less than 4 grams sulfur (S) per 100 grams of particle.
Clause 4. The reactor system according to clause 3, wherein the sulfur uptake capacity of the second particles is no greater than 20 grams sulfur (S) per 100 grams of particle.
Clause 5. The reactor system according to clause 3 or claim 4, wherein the sulfur uptake capacity of the first particles is no less than 5 grams sulfur (S) per 100 grams of particle and no greater than 36 grams sulfur (S) per 100 grams of particle.
Clause 6. The reactor system according to any one of clauses 1-5, wherein the first particle comprises iron (Fe) and the second particle comprises iron (Fe) and chromium (Cr).
Clause 7. The reactor system according to any one of clauses 1-5, wherein the first particle comprises nickel (Ni) and the second particle comprises iron (Fe) and chromium (Cr).
Clause 8. The reactor system according to any one of clauses 1-7, the first particle bed configured to operate at a first temperature and the second particle bed configured to operate at a second temperature, the second temperature being different from the first temperature.
Clause 9. The reactor system according to any one of clauses 1-8, further comprising a first reactor and a second reactor in fluid communication with the first reactor, the first reactor comprising the gas inlet and the first particle bed; and the second reactor comprising the second particle bed and the gas outlet.
Clause 10. The reactor system according to any one of clauses 1-9, further comprising a plurality of additional gas inlets positioned downstream of the gas inlet.
Clause 11. The reactor system according to clause 1, comprising a reactor comprising both the first particle bed and the second particle bed.
Clause 12. A method of operating a reactor system, the method comprising: providing a gas stream comprising hydrogen sulfide (H₂S) gas to a first particle bed, the first particle bed comprising a plurality of first particles, the first particles comprising a support material, sulfur (S) material, and a first metal; controlling a temperature of the first particle bed to be between 50° C. and 800° C.; contacting an output stream from the first particle bed with a second particle bed, the second particle bed comprising a plurality of second particles, the second particles comprising a support material, sulfur (S) material, iron (Fe), and chromium (Cr); and controlling a temperature of the second particle bed to be between 50° C. and 800° C.; and collecting an output stream from the second particle bed, the output stream comprising hydrogen (H₂) gas.
Clause 13. The method according to clause 12, wherein 40-90 mol % of the hydrogen sulfide (H₂S) in the gas stream is converted to hydrogen gas (H₂) in the first particle bed.
Clause 14. The method according to clause 12 or claim 13, the output stream from the second particle bed comprising less than 5 mol % of the hydrogen sulfide (H₂S) in the gas stream.
Clause 15. The method according to any one of clauses 12-14, further comprising: regenerating the first particle bed comprising providing a first inert gas to the first particle bed; and regenerating the second particle bed comprising providing a second inert gas to the second particle bed.
Clause 16. The method according to clause 15, wherein regenerating the first particle bed is conducted at a temperature between 500° C. and 1200° C.
Clause 17. The method according to clause 15 or 16, wherein regenerating the second particle bed is conducted at a temperature between 500° C. and 1200° C.
Clause 18. The method according to any one of clauses 12-17, further comprising providing hydrogen sulfide (H₂S) gas at a plurality of locations along the first particle bed.
Clause 19. The method according to any one of clauses 12-18, further comprising providing the output stream from the first particle bed at a plurality of locations along the second particle bed.
Clause 20. The method according to any one of clauses 12-19, the reactor system comprising a reactor, wherein the gas stream is provided to an inlet of the reactor; and wherein the output stream is collected from an outlet of the reactor.
Clause 21. The method according to any one of clauses 12-19, the reactor system comprising a first reactor and a second reactor, wherein the gas stream is provided to an inlet of the first reactor; and wherein the output stream is collected from an outlet of the second reactor.

1. A reactor system, comprising:
a gas inlet configured to receive a gas stream comprising hydrogen sulfide (H₂S);
a first particle bed comprising a plurality of first particles,
the first particles comprising a support material and a first metal material, the first metal material comprising at least one of: iron (Fe), nickel (Ni), chromium (Cr), cobalt (Co), vanadium (V), copper (Cu), and cerium (Ce); and
the first particle bed in fluid communication with the gas inlet; and
a second particle bed comprising a plurality of second particles,
the second particles comprising a support material and a second metal material comprising at least one of: iron (Fe), chromium (Cr), nickel (Ni), and vanadium (V),
the second particle bed being in fluid communication with the first particle bed;
wherein a sulfur uptake capacity of the first particles is greater than a sulfur update capacity of the second particles; and
a gas outlet in fluid communication with the second particle bed, the gas outlet being configured to provide an output stream comprising hydrogen (H₂) gas.

2. (canceled)

3. The reactor system according to claim 1, wherein the sulfur uptake capacity of the first particles is no less than 4 grams sulfur (S) per 100 grams of particle.

4. The reactor system according to claim 3, wherein the sulfur uptake capacity of the second particles is no greater than 20 grams sulfur (S) per 100 grams of particle.

5. The reactor system according to claim 4, wherein the sulfur uptake capacity of the first particles is no less than 5 grams sulfur (S) per 100 grams of particle and no greater than 36 grams sulfur (S) per 100 grams of particle.

6. The reactor system according to claim 5, wherein the first particle comprises iron (Fe) and the second particle comprises iron (Fe) and chromium (Cr).

7. The reactor system according to claim 5, wherein the first particle comprises nickel (Ni) and the second particle comprises iron (Fe) and chromium (Cr).

8. The reactor system according to claim 5, the first particle bed configured to operate at a first temperature and the second particle bed configured to operate at a second temperature, the second temperature being different from the first temperature.

9. The reactor system according to claim 4, further comprising a first reactor and a second reactor in fluid communication with the first reactor,
the first reactor comprising the gas inlet and the first particle bed; and
the second reactor comprising the second particle bed and the gas outlet.

10. The reactor system according to claim 4, further comprising a plurality of additional gas inlets positioned downstream of the gas inlet.

11. The reactor system according to claim 4, comprising a reactor comprising both the first particle bed and the second particle bed.

12-21. (canceled)
